(19) United States
(12) Patent Application Publication
(10) Pub. No.: US 2023/0343084 A1
(43) Pub. Date: Oct. 26, 2023

(54) DATA PROCESSING APPARATUS, DATA PROCESSING METHOD, AND DATA PROCESSING PROGRAM

(71) Applicant: Nippon Telegraph and Telephone Corporation, Tokyo (JP)

(72) Inventors: Yuki URABE, Musashino-shi, Tokyo (JP); Kimio TSUCHIKAWA, Musashino-shi, Tokyo (JP); Fumihiro YOKOSE, Musashino-shi, Tokyo (JP); Sayaka YAGI, Musashino-shi, Tokyo (JP)

(21) Appl. No.: 18/025,518

(22) PCT Filed: Sep. 11, 2020
(86) PCT No.: PCT/JP2020/034608

§ 371 Date: Mar. 9, 2023

(51) Int. Cl. G06V 10/86; G06V 20/50; G06V 10/40; G06V 10/22; G06V 10/94; G06V 10/74

(52) U.S. Cl. CPC G06V 10/86; G06V 10/22; G06V 10/40; G06V 10/761; G06V 10/945; G06V 20/50

(57) ABSTRACT

A data processing device includes an acquisition unit, a generation unit, and a recognition unit. The acquisition unit acquires a plurality of images of a window. The generation unit extracts image portions of GUI component possibilities from each one of the plurality of images acquired by the acquisition unit, and generates, for each acquired image, arrangement data regarding arrangement places where the extracted image portions are arranged. The recognition unit compares image portions of predetermined GUI component possibilities in which arrangement places correspond to each other between a plurality of pieces of arrangement data generated by the generation unit, and recognizes the predetermined GUI component possibilities as operable GUI components in a case where the image portions of the predetermined GUI component possibilities are different from each other.

### TECHNICAL FIELD

The present disclosure relates to a data processing device, a data processing method, and a data processing program.

### BACKGROUND ART

Nowadays, many companies use a variety of types of software for business. Examples of the software used for business include a business system (e.g., customer management or accounting management) and a general-purpose application (e.g., a mailer or a browser).

Persons in charge of business share a software manual among themselves in some cases. For example, some companies provide products and services to customers through business mainly including operation of terminals in a business system. In this case, for example, a manual defines a procedure for operating the business system for providing the products and services. In the manual, for example, an operation procedure for providing the same product or service is defined for each product or service.

With respect to implementation of business, a person in charge of business is generally expected to perform processing necessary for providing a product or a service in accordance with the manual. In the business in accordance with the manual, it is desirable that the same product or service be processed in accordance with the same operation procedure.

However, in practice, a variety of irregular events occur in business. Examples of the irregular events include an event in which a customer makes a change to an order the customer has placed, an event in which a product is out of stock, and an event in which a mistake in operating a terminal occurs. Since a variety of irregular events that have not been conceivable at the time of creation of the manual occur in actual business, it is often not realistic to define in advance all operation procedures for irregular events. In addition, it is difficult for a person in charge of business to learn a wide variety of operation methods for irregular events.

As described above, it is often not realistic to process all cases by a procedure defined in advance, and in practice, the procedure for processing the same product or service is generally different for every case.

From a viewpoint of business analysis, grasping irregular events as described above is useful for business improvement. When consideration is made for business improvement, it is desirable to comprehensively grasp an actual state of business including irregular events in addition to regular operations.

For example, regarding regular business, it is desirable to check whether the business is performed in accordance with the operation procedure defined in the manual. Furthermore, in order to consider a more efficient procedure or an automatable procedure, it is desirable to grasp the actual state of business.

On the other hand, regarding irregular events, it is desirable to grasp the actual state of business such as the kinds of irregular events that usually occur, the frequency of occurrence of the irregular event, and how the irregular event is processed by a person in charge of business.

Grasping such an actual state of business allows the company to make use of the actual state of business for consideration of a solution that allows a person in charge of business to smoothly perform business.

Thus, it has been proposed to display an operation procedure in the form of a flowchart in order to grasp the actual state of business (Non Patent Literature 1). The display technique in which an operation procedure is displayed in the form of a flowchart is effective for business analysis for the purpose of specifying the business or work to be automated for a company that introduces robotic process automation (RPA).

In the above-described display technique, each one of a plurality of operation procedures is displayed as a node, and the nodes are arranged so that a business process is visualized. Specifically, first, operation logs are recorded for cases such as applications for various services. The operation logs include, for example, the time of operation by an operator, the type of operation (also referred to as an operation type), and identification information (that is, a case ID) for specifying the case. Next, the operation logs are used as an input for generating nodes. Thereafter, nodes are arranged for each case and operation procedures for the same type of operation are superimposed as the same node, so that a difference in operations in each case is grasped.

Regarding acquisition of operation logs, a technology for efficiently acquiring a display state of a graphical user interface (GUI) has been proposed (Patent Literature 1). This technology provides a mechanism for acquiring an operation log on the basis of granularity of an operation on a GUI component by an operator. In this technology, GUI components constitute an operation screen of a GUI application. When an event occurs, attribute values of the GUI components are acquired from the operation screen. Then, a change to a GUI component is found before and after occurrence of the event. In this way, the event that has caused the change in the attribute value (that is, an operation event that has a meaning in the business) is extracted, and an operation portion is specified.

### CITATION LIST

### Patent Literature

Patent Literature 1: JP 2015-153210 A

### Non Patent Literature

Non Patent Literature 1: Shiro OGASAWARA, Kimio TSUCHIKAWA, Mamoru HYODO, Tsutomu MARUYAMA, “Development of Business Process Visualization and Analysis System Using Business Execution History” [online], [searched on Sep. 11, 2020], Internet (https://www.ntt.co.jp/journal/0902/filesjn200902040.pdf)

### SUMMARY OF INVENTION

### Technical Problem

However, it cannot be said that operation logs can be easily collected in the above-described conventional technology.

For example, in actual business, not only a business system but also a variety of applications such as a mailer, a browser, and packaged software (e.g., word processing, spreadsheet, and presentation) are generally used in the process of business. In order to grasp the situation of business performed by a person in charge of business, it is conceivable to develop a mechanism for acquiring attribute values of GUI components in accordance with execution environments of all these applications and specifying a change to a GUI component. However, the mechanism for acquiring the states of the GUI components may vary depending on the application execution environment. Thus, in a case where a company develops a mechanism for acquiring the GUI components for each application, this mechanism requires some development cost. In practice, the development cost is high, and it is not realistic to develop such a mechanism in some cases.

A case is assumed in which a company has developed a mechanism as described above for a specific application. However, in this case, when the specifications of the application have changed due to version upgrade of the target application, the company may need to modify the mechanism in accordance with the specification change. As a result, costs related to the modification may be required.

In recent years, thin client environments have been widely used in companies for the purpose of effective use of computer resources and security measures. In a thin client environment, an application is not installed on a client terminal, which is a terminal directly operated by a person in charge of business. Instead, the application is installed on another terminal connected to the client terminal.

In a thin client environment, an operation screen provided by an application is displayed as an image on a client terminal. A person in charge of business operates the application installed on another terminal through the displayed image. In this case, the operation screen is simply displayed as an image on the terminal on which the person in charge of business actually performs the operation. Thus, it is difficult to specify a GUI component and a change to the GUI component from the client terminal.

As described above, in a business using a wide variety of applications or in a thin client environment, it is not easy to collect, as an operation log, an operation on a GUI component performed on an application of a person in charge of business.

The present application has been made in view of the above, and is aimed at easily collecting operation logs.

### Solution to Problem

A data processing device according to an embodiment of the present disclosure includes: an acquisition unit that acquires a plurality of images of a window; a generation unit that generates, after extracting image portions of GUI component possibilities from each one of the plurality of images acquired by the acquisition unit, arrangement data regarding arrangement places where the extracted image portions are arranged for each acquired image; and a recognition unit that recognizes, after comparing image portions of predetermined GUI component possibilities in which arrangement places correspond to each other between a plurality of pieces of arrangement data generated by the generation unit, the predetermined GUI component possibilities as operable GUI components in a case where the image portions of the predetermined GUI component possibilities are different from each other.

### Advantageous Effects of Invention

According to one aspect of the embodiment, operation logs can be easily collected.

### BRIEF DESCRIPTION OF DRAWINGS

FIG. 1 is a diagram illustrating an example of an operation log acquisition system according to an embodiment.

FIG. 2A is an explanatory diagram illustrating an example of acquisition processing of acquiring an operation event.

FIG. 2B is an explanatory diagram illustrating an example of acquisition processing of acquiring an operation event.

FIG. 3 is an explanatory diagram illustrating an example of classification processing of classifying the same window.

FIG. 4 is an explanatory diagram illustrating an example of generation processing of generating a GUI component graph structure.

FIG. 5 is an explanatory diagram illustrating an example of assignment processing of assigning a unique ID to a node of a GUI component that is operated from the GUI component graph structure.

FIG. 6 is an explanatory diagram illustrating an example of GUI component specifying processing of specifying a GUI component at an operation portion from a captured image and an operation event.

FIG. 7 is an explanatory diagram illustrating an example of unique ID specifying processing of specifying a unique ID of an operation portion.

FIG. 8 is a flowchart illustrating an example of processing for acquiring an operation event, executed by a data processing device according to the embodiment.

FIG. 9 is a flowchart illustrating an example of processing for generating a sample GUI graph structure, executed by the data processing device according to the embodiment.

FIG. 10 is a flowchart illustrating an example of processing for generating an operation log, executed by the data processing device according to the embodiment.

FIG. 11 is a diagram illustrating an example of a hardware configuration.

### DESCRIPTION OF EMBODIMENTS

An embodiment of the present disclosure will be described below in detail with reference to the drawings. Note that the present invention is not limited by this embodiment. Details of one or more embodiments are set forth in the following description and drawings. Note that a plurality of the embodiments can be appropriately combined without causing contradiction in processing contents. In the following one or more embodiments, the same portions are denoted by the same reference numerals, and redundant description will be omitted.

### 1. Outline

This section describes an outline of some forms of implementation described in the present specification. Note that this outline is provided for the convenience of a reader and is not intended to limit the present invention or the embodiment described in the following sections.

A variety of business analyses have conventionally been proposed for the purpose of improving business that uses a terminal such as a personal computer (PC). One of the business analyses is to find a work to which RPA can be applied from operation logs of operations on the PC.

The work to which RPA can be applied is, for example, a mechanical work such as periodically repeating a series of operation procedures. In a case where a work to which RPA can be applied is found from the operation logs, it is possible to automate the mechanical work by applying RPA.

Meanwhile, application of RPA may require detailed operation logs. The detailed operation logs are, for example, operation logs at a granularity level for operations on GUI components. The term granularity means the level of detail or detailedness of data. For example, an operation log at a level for operations on GUI components contains a component name of the GUI component (e.g., text box or radio button), an input value (e.g., a character string or a numerical value), and the like.

Regarding acquisition of the operation logs described above, an operation log acquisition technology that uses object data of the GUI components has been proposed (Patent Literature 1). In this operation log acquisition technology, first, hyper text markup language (HTML) information of the browser is acquired at the timing of an operation event for the browser. Next, the acquired HTML information is analyzed, and the states of the GUI components (e.g., the component name and the input value of the GUI component) are acquired. In other words, the states of the GUI components are acquired as object data of objects included in the operation screen. Thereafter, the states of the GUI components are compared with the states of the GUI components acquired at the time of the previous operation event. In a case where the state of a GUI component has changed, the state of the GUI component is recorded in the operation log.

However, in practice, in a case where a wide variety of applications are used in business, the development cost may pose a problem in the above-described operation log acquisition technology.

Specifically, a method of acquiring the states of the GUI components is different for every application execution environment. In a case where software for acquiring operation logs is developed for every execution environment, development of the software may be considerably costly.

Thus, a data processing device according to the embodiment executes operation log acquisition processing described below to apply, to business in which a wide variety of applications are used, a business analysis that requires operation logs at a level for operations on GUI components, such as applying RPA. The data processing device acquires an operation log through three stages.

The first stage is acquisition of an operation event. In the first stage, the data processing device acquires, at the timing of the operation event, an event type (mouse or keyboard), the portion where the operation has been performed, and a captured image of the operation screen of the application.

The second stage is generation of a sample GUI component graph structure. In the second stage, first, the data processing device acquires, as an image portion of a GUI component possibility, a frame (e.g., rectangular) portion or a character string portion from the captured image of the operation screen. Then, the data processing device generates a GUI component graph structure on the basis of position information of the acquired portion. The GUI component graph structure indicates how the image portions of the GUI component possibilities are arranged in the operation screen.

The data processing device acquires, at the timing of each operation event, the event type, the portion where the operation has been performed, and the captured image of the operation screen described above. Then, the data processing device generates a plurality of GUI component graph structures from a plurality of captured images of the same operation screen (that is, the same window).

Next, the data processing device compares the plurality of GUI component graph structures, and specifies, as a portion where an operable GUI component is arranged, a portion where there is a change in the image portion of the GUI component possibility. The data processing device allocates a unique ID to the specified portion to generate a sample GUI component graph structure as a graph structure serving as a sample of portions where operable GUI components are arranged.

The third stage is generation of an operation log. In the third stage, first, the data processing device newly generates a GUI component graph structure from the captured image of the operation screen for each operation event in time series. Then, the data processing device specifies which portion of the newly generated GUI component graph structure has been operated on the basis of the portion where the operation has been performed in each operation event.

Next, the data processing device compares the newly generated GUI component graph structure with the sample GUI component graph structure. The data processing device acquires a unique ID corresponding to the operated portion in the newly generated GUI component graph structure from among unique IDs included in the sample GUI component graph structure. On the basis of the acquired unique ID, the data processing device specifies what the GUI component arranged at this portion is.

Thereafter, the data processing device compares the operation event with the previous operation event. In a case where there is a change in the operation event, the data processing device records the operation event in an operation log. In this way, the data processing device can acquire the operation log.

As described above, the data processing device generates, for general purposes, operation logs at a level for operations on GUI components from the operation screen of the application. This allows the data processing device to generate operation logs at the granularity of an operation on a GUI component regardless of the application.

### 2. Configuration of Operation Log Acquisition System

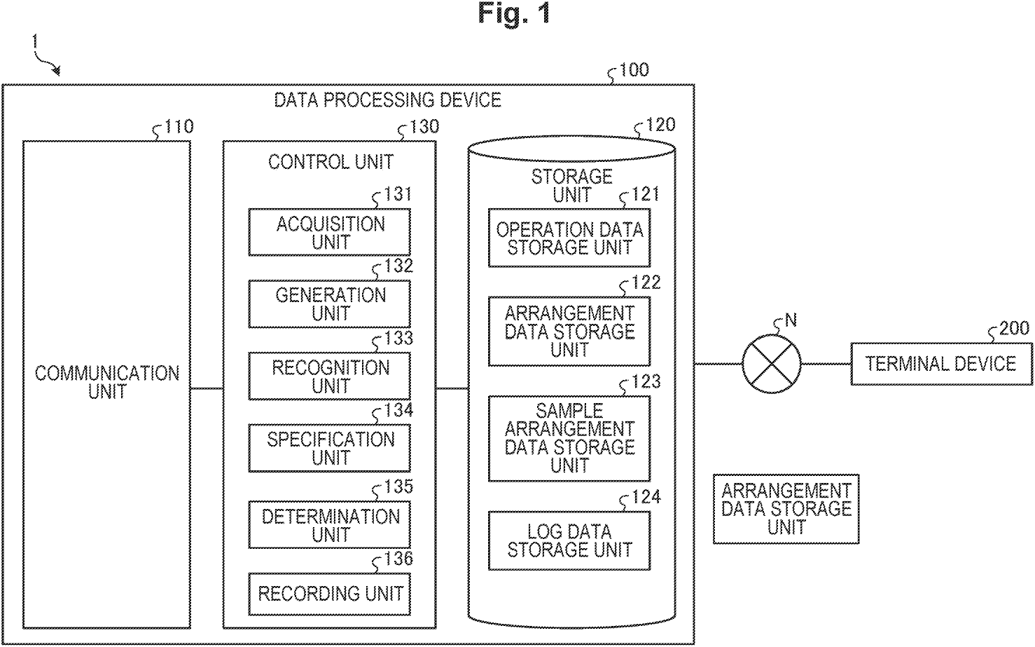

First, a configuration of an operation log acquisition system according to the embodiment will be described with reference to FIG. 1.

FIG. 1 is a diagram illustrating an example of an operation log acquisition system 1 according to the embodiment. As illustrated in FIG. 1, the operation log acquisition system 1 includes a data processing device 100 and a terminal device 200. Although not illustrated in FIG. 1, the operation log acquisition system 1 may include a plurality of the data processing devices 100 and a plurality of the terminal devices 200.

In the operation log acquisition system 1, each of the data processing device 100 and the terminal device 200 are connected to a network N in a wired or wireless manner. The network N is, for example, the Internet, a wide area network (WAN), or a local area network (LAN). Components of the operation log acquisition system 1 can communicate with each other via the network N.

The data processing device 100 is an information processing device that executes processing for acquiring logs of software operation. The data processing device 100 may be any type of information processing device including a server.

The terminal device 200 is an information processing device used by a user. The user is, for example, a person in charge of business. The person in charge of business uses various types of software such as a business system and a general-purpose application on the terminal device 200. The terminal device 200 may be any type of information processing device including a client device such as a smartphone, a desktop computer, a laptop computer, or a tablet computer.

In the example in FIG. 1, the data processing device 100 is illustrated as a data processing device arranged outside the terminal device 200, but the present invention is not limited thereto. The data processing device 100 may be installed as a data processor arranged inside the terminal device 200.

Next, a configuration example of the data processing device 100 will be described.

As illustrated in FIG. 1, the data processing device 100 includes a communication unit 110, a storage unit 120, and a control unit 130. Note that the data processing device 100 may include an input unit (e.g., a keyboard or a mouse) that receives various operations from an administrator or the like who uses the data processing device 100, and a display unit (e.g., an organic electro luminescence (EL) or a liquid crystal display) for displaying various types of information.

### (Communication Unit 110)

The communication unit 110 is constituted by, for example, a network interface card (NIC). The communication unit 110 is connected to a network in a wired or wireless manner. The communication unit 110 may be communicably connected to the terminal device 200 via the network N. The communication unit 110 can transmit and receive information to and from the terminal device 200 via the network.

### (Storage Unit 120)

The storage unit 120 is constituted by, for example, a semiconductor memory element such as a random access memory (RAM) or a flash memory, or a storage device such as a hard disk or an optical disk. As illustrated in FIG. 1, the storage unit 120 includes an operation data storage unit 121, an arrangement data storage unit 122, a sample arrangement data storage unit 123, and a log data storage unit 124.

### (Operation Data Storage Unit 121)

The operation data storage unit 121 stores operation data regarding software operation. The operation data storage unit 121 stores operation data acquired by an acquisition unit 131 to be described later. For example, the operation data storage unit 121 stores, as the operation data, the time of occurrence of a user operation event (e.g., an operation on the mouse or the keyboard), the position of occurrence of the operation event, and a captured image of the operation screen (that is, the window) .

### (Arrangement Data Storage Unit 122)

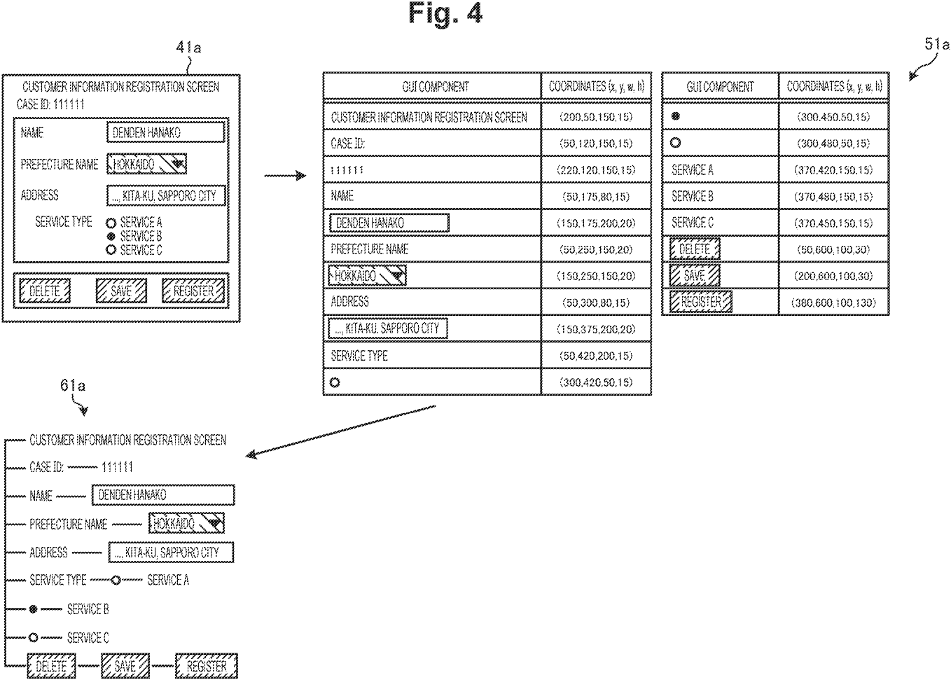

The arrangement data storage unit 122 stores arrangement data regarding arrangement of GUI components. The arrangement data storage unit 122 stores arrangement data generated by a generation unit 132 to be described later. For example, the arrangement data storage unit 122 stores a GUI component graph structure as the arrangement data. The GUI component graph structure is described below in detail with reference to FIG. 4.

### (Sample Arrangement Data Storage Unit 123)

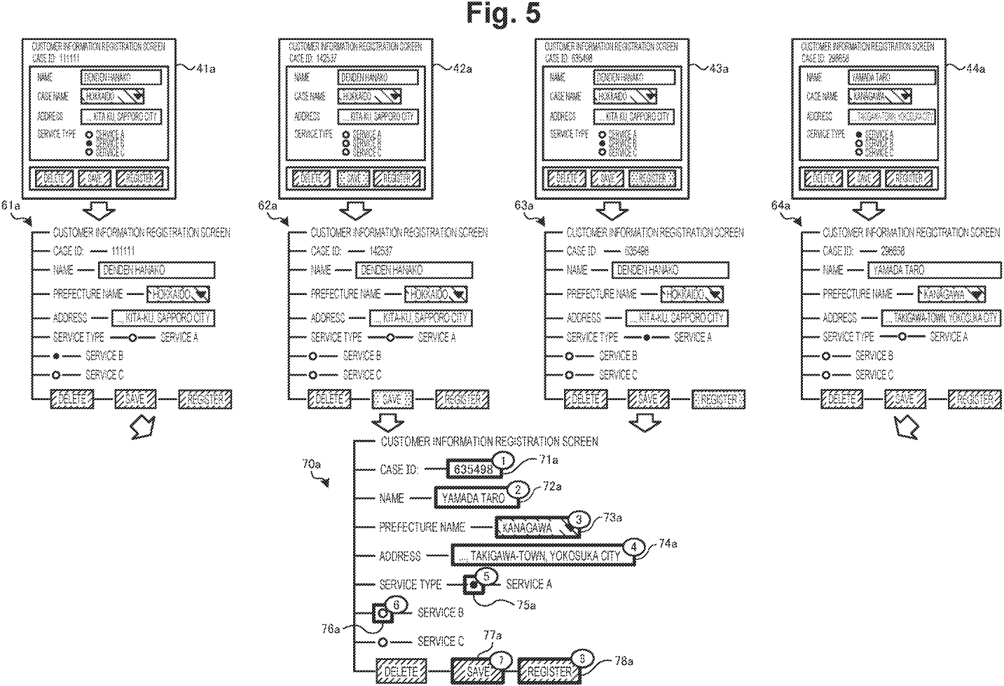

The sample arrangement data storage unit 123 stores sample arrangement data regarding arrangement of GUI components recognized as operable GUI components. The sample arrangement data storage unit 123 stores sample arrangement data generated by a recognition unit 133 to be described later. For example, the sample arrangement data storage unit 123 stores a sample GUI component graph structure as the sample arrangement data. The sample GUI component graph structure is described below in detail with reference to FIG. 5.

### (Log Data Storage Unit 124)

The log data storage unit 124 stores log data regarding logs of software operation. The log data storage unit 124 stores log data recorded by a recording unit 136 to be described later. For example, the log data storage unit 124 stores a log of an operation on a GUI component as the log data.

### (Control Unit 130)

The control unit 130 is a controller, and is implemented by, for example, a processor such as a central processing unit (CPU) or a micro processing unit (MPU) executing various programs (corresponding to an example of a data processing program) stored in a storage device inside the data processing device 100 using a RAM or the like as a work area. Alternatively, the control unit 130 may be constituted by, for example, an integrated circuit such as an application specific integrated circuit (ASIC), a field programmable gate array (FPGA), or a general purpose graphic processing unit (GPGPU).

As illustrated in FIG. 1, the control unit 130 includes the acquisition unit 131, the generation unit 132, the recognition unit 133, a specification unit 134, a determination unit 135, and the recording unit 136, and implements or executes a function or an action of information processing described below. One or more processors of the data processing device 100 can implement a function of each control unit in the control unit 130 by executing an instruction stored in one or more memories of the data processing device 100. Note that the internal configuration of the control unit 130 is not limited to the configuration illustrated in FIG. 1, and may be another configuration as long as information processing to be described later is performed. For example, the recognition unit 133 may perform all or part of information processing to be described later with respect to a unit other than the recognition unit 133.

### (Acquisition Unit 131)

The acquisition unit 131 acquires various types of information used to execute processing for acquiring logs of software operation. For example, the acquisition unit 131 acquires operation data regarding software operation.

The acquisition unit 131 receives the operation data from the terminal device 200. The acquisition unit 131 stores the received operation data in the operation data storage unit 121.

The acquisition unit 131 acquires an operation event as the operation data. In addition, the acquisition unit 131 acquires, at the timing of the operation event, the time of occurrence of the operation, the portion where the operation has been performed, and a captured image of the operation screen.

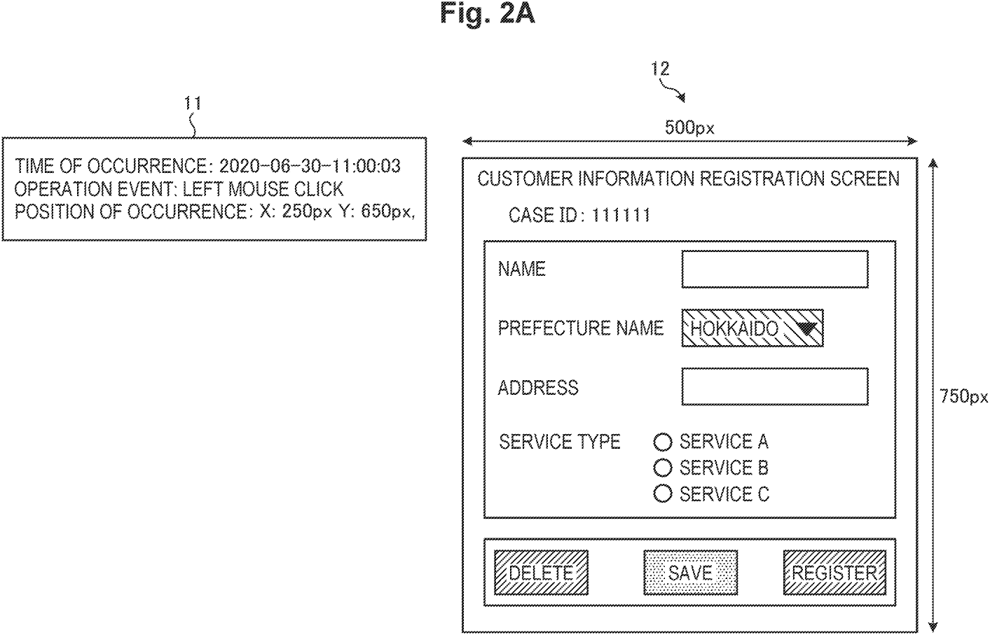

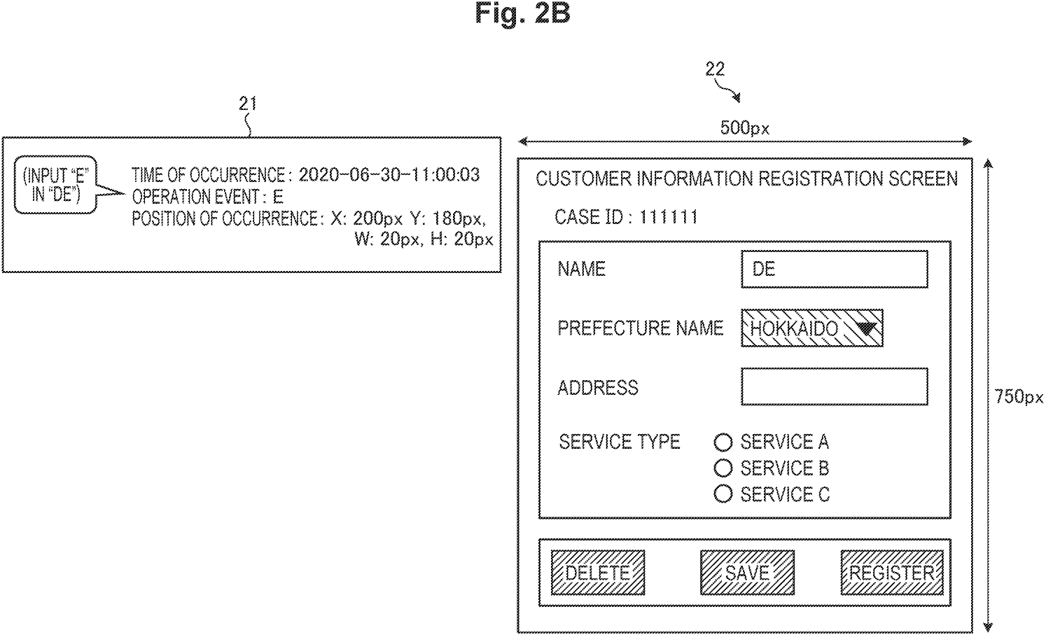

FIGS. 2A and 2B are explanatory diagrams illustrating examples of acquisition processing of acquiring an operation event. The acquisition unit 131 acquires the time and position of occurrence of a user operation event (e.g., an operation on the mouse or the keyboard). In addition, the acquisition unit 131 acquires a captured image of the operation screen (that is, the window). The acquisition unit 131 acquires, at the timing of each operation event, the event type (e.g., mouse or keyboard), the portion where the operation has been performed, and the captured image of the operation screen.

In the example in FIG. 2A, the acquisition unit 131 acquires a mouse click as the operation event. The acquisition unit 131 acquires an operation event 11 and a captured image 12. The operation event 11 is a left mouse click. The time of occurrence of the operation event 11 is 11:00:03 on Jun. 30, 2020. The X coordinate of the position of occurrence of the operation event 11 is 250 px. The Y coordinate of the position of occurrence of the operation event 11 is 650 px. The captured image 12 is a captured image of a customer information registration screen.

In the example in FIG. 2B, the acquisition unit 131 acquires a keyboard input as the operation event. The acquisition unit 131 acquires an operation event 21 and a captured image 22. The operation event 21 is “input E in DE”. The time of occurrence of the operation event 21 is 11:00:03 on Jun. 30, 2020. The X coordinate of the position of occurrence of the operation event 11 is 200 px. The Y coordinate of the position of occurrence of the operation event 11 is 180 px. A width W of a text box where E in DE has been input is 20 px. A height H of the text box is 20 px. The captured image 22 is a captured image of the customer information registration screen.

The acquisition unit 131 acquires, at the timing of a user operation event (e.g., an operation on the mouse or the keyboard), information regarding the operation event from the terminal device 200.

The acquisition unit 131 acquires the type of the event (click or key) as the information regarding the operation event.

The acquisition unit 131 acquires the position of the operation event as the information regarding the operation event. In a case where the acquisition unit 131 cannot acquire the position of the operation event, the acquisition unit 131 may specify the position of the operation event from a change in the operation screen caused by the preceding or subsequent operation.

In a case where the application is running on the terminal device 200, the acquisition unit 131 may acquire active window identification information. The active window is a window that receives an operation by the mouse or the keyboard. The active window identification information is, for example, data such as a window handle and a window title.

The acquisition unit 131 acquires a captured image of the window as the information regarding the operation event. In a case where the application is running on the terminal device 200, a captured image of the active window is acquired. In a case where the terminal device 200 is used in a thin client environment, a captured image of the entire operation screen is acquired.

The acquisition unit 131 may acquire a captured image of the operation screen not immediately after a user operation event but every designated time. Then, the acquisition unit 131 may compare the time of occurrence of the user operation event with the acquisition time of a captured image later, and associate the time of occurrence of the operation event with an image captured immediately after the time of occurrence of the operation event.

### (Generation Unit 132)

Returning to FIG. 1, the generation unit 132 generates various types of information used to execute processing for acquiring logs of software operation. For example, the generation unit 132 generates arrangement data regarding arrangement of GUI components. The generation unit 132 generates a GUI component graph structure to be described later as the arrangement data. The generation unit 132 stores the generated arrangement data in the arrangement data storage unit 122.

The generation unit 132 acquires operation data from the operation data storage unit 121. For example, the generation unit 132 collects captured images of the same operation screen (that is, the same window) from captured images stored in the operation data storage unit 121. The following two methods are conceivable as a method of collecting the same operation screen. A first method is a method of collecting windows having the same application name and window title on the assumption that windows having the same application name and window title have the same operation screen configuration. However, there is a case where windows having the same application name and window title have different operation screen configurations. Thus, as a second method, there is a method of collecting windows having similar appearances.

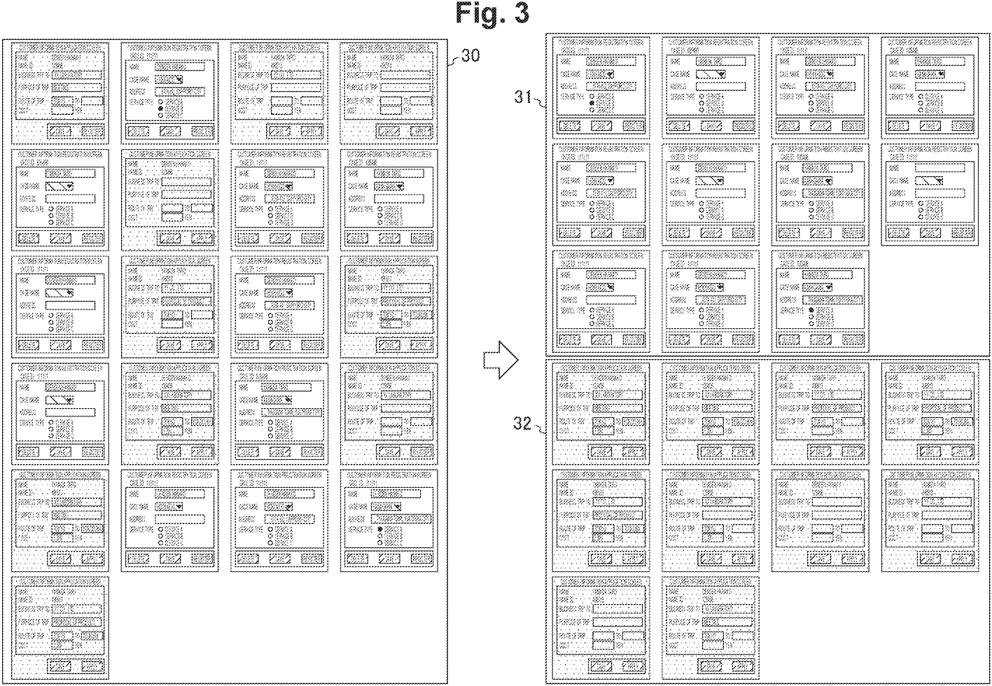

FIG. 3 is an explanatory diagram illustrating an example of classification processing of classifying the same window. The generation unit 132 aggregates, on a window-by-window basis, captured images of the same window. In the example in FIG. 3, the generation unit 132 classifies a plurality of captured images 30 of the window into a plurality of captured images 31 of the same window and a plurality of captured images 32 of the same window. After the classification, the plurality of captured images 31 of the same window belongs to a first class. The plurality of captured images 32 of the same window belongs to a second class.

As an example, the generation unit 132 collects, on a window-by-window basis, captured images of the same window on the basis of the active window identification information. As another example, the generation unit 132 may cluster captured images. That is, the generation unit 132 may classify captured images on the basis of a similarity in appearance of the captured images. Regarding a method of the clustering, for example, the generation unit 132 may use pixels of the captured images to vectorize the captured images. Then, the generation unit 132 may use a clustering technique such as K-means clustering to classify the captured images into K clusters (K is any natural number).

Returning to FIG. 1, the generation unit 132 extracts partial images of GUI component possibilities from a captured image of an operation screen. Then, the generation unit 132 generates a graph structure on the basis of the partial images of the GUI component possibilities and the coordinates of the partial images.

The generation unit 132 extracts partial images of GUI component possibilities from each one of a plurality of captured images of the same window. Then, the generation unit 132 generates a GUI component graph structure on the basis of the coordinates of the partial images. As described above, the generation unit 132 generates a GUI component graph structure from captured images of an operation screen.

For example, the generation unit 132 acquires frame (e.g., rectangular) portions or character string portions from a captured image of the operation screen. For example, the generation unit 132 extracts the rectangular portions in the captured image as partial images of GUI component possibilities. The generation unit 132 generates a GUI component graph structure on the basis of position information of the acquired portions. The generation unit 132 generates a GUI component graph structure on the basis of the positions of the rectangular portions, for example.

In an example of generating a GUI component graph structure, first, the generation unit 132 acquires a partial image of a portion of a frame or a character string from a captured image of an operation screen and coordinates of the partial image. Next, the generation unit 132 scans the captured image from the upper left (e.g., where the coordinates are (x, y) = (0, 0)) of the captured image to the lower right of the captured image, and specifies a partial image that appears at the uppermost and leftmost position. Then, focusing on the y coordinate and the height h of the partial image, the generation unit 132 uses a manually set threshold t to determine whether there is another partial image in the range from (y - t) px to (y + h + t) px. In a case where there is another partial image in the range, the generation unit 132 places the partial image and the other partial image in the same row in a graph. Furthermore, the generation unit 132 focuses on the x coordinates of the partial images, arranges the partial images in ascending order of the x coordinate, and connects the partial images with edges.

The generation unit 132 continues the above processing until all the partial images are processed. The generation unit 132 ends the processing by determining the order of the rows on the basis of the y coordinate of each row.

In a case where the application is a browser, the generation unit 132 does not directly acquire the states of the GUI components from HTML information, but acquires portions of text labels, portions of text boxes, or the like as image portions of GUI component possibilities. Then, the generation unit 132 generates a GUI component graph structure on the basis of position information of such portions. In a case where the application is a Windows (registered trademark) application, the generation unit 132 does not directly perform the states of the GUI components by using UI automation, but acquires portions of text labels, portions of check boxes, portions of text boxes, or the like as image portions of GUI component possibilities. Then, the generation unit 132 generates a GUI component graph structure on the basis of position information of such portions.

The GUI component graph structure is a graph structure that indicates how the image portions of the GUI component possibilities are arranged in the operation screen. In the GUI component graph structure, the image portions of the GUI component possibilities are represented by nodes, and arrangement relationships between the image portions of the GUI component possibilities are represented by edges.

FIG. 4 is an explanatory diagram illustrating an example of generation processing of generating a GUI component graph structure. In the example in FIG. 4, the generation unit 132 extracts partial images 51a of GUI component possibilities from a captured image 41a of the operation screen. For example, the generation unit 132 extracts rectangular portions or character string portions from the captured image 41a of the operation screen.

As illustrated in FIG. 4, the partial images 51a of the GUI component possibilities include partial images of a text label, a text box, a pull-down menu, a radio button, a button, and the like. For example, a GUI component “customer information registration screen” is a text label. A GUI component “Hokkaido” is a pull-down menu. A GUI component “DENDEN Hanako” is a text box. A GUI component “white circle” is a radio button.

As illustrated in FIG. 4, the partial images of the GUI component possibilities are associated with coordinates. The coordinates (x, y, w, h) represent the position (that is, xy coordinates), width, and height of the GUI component possibility. For example, the coordinates of the GUI component “customer information registration screen” are (200, 50, 150, 15).

The generation unit 132 extracts, as a partial image of a GUI component possibility, a partial image that satisfies a predetermined condition regarding the appearance of the GUI component, from the captured image of the operation screen. For example, the predetermined condition regarding the appearance of the GUI component is a condition that the object is frame-shaped. Alternatively, for example, the predetermined condition is a condition that the object is a text. For example, the generation unit 132 cuts out, from the captured image, a rectangle or a character string that can be a GUI component. Furthermore, the generation unit 132 specifies the coordinates (x, y, w, h) of the cut-out rectangle or character string. The generation unit 132 can cut out a rectangle or a character string by using an optical character recognition (OCR) technology such as Open Source Computer Vision Library (OpenCV) or Tesseract.

In the example in FIG. 4, the generation unit 132 generates a GUI component graph structure 61a from the partial images 51a of the GUI component possibilities. The GUI component graph structure 61a is a data structure in which partial images of GUI component possibilities are represented as nodes and positional relationships between the partial images of the GUI component possibilities are represented as edges. For example, the GUI component “customer information registration screen” is a node. A GUI component “case ID:” and a GUI component “111111” are also nodes. A line connecting the GUI component “case ID:” to the GUI component “111111” is an edge.

Regarding generation of a GUI component graph structure, first, the generation unit 132 focuses on the y coordinate and the height h of a partial image of a GUI component possibility. In a case where the y coordinates and the heights h of partial images of a plurality of GUI component possibilities correspond to a threshold set in advance, the generation unit 132 generates a GUI component graph structure such that the partial images of the plurality of GUI component possibilities are arranged in the same row. For example, in a case where the threshold is set to 5 px, the generation unit 132 generates a GUI component graph structure such that the row of the image of a first GUI component possibility is the same as the row of the image of a second GUI component possibility having a y coordinate in the range of “-5 px” to “h + 5 px” from the y coordinate of the image of the first GUI component possibility.

Next, the generation unit 132 focuses on the x coordinates of the partial images of the plurality of GUI component possibilities. The generation unit 132 determines the order of the images of the GUI component possibilities in the same row on the basis of the magnitude of the x coordinate.

In the example in FIG. 4, for example, the y coordinate of the GUI component “customer information registration screen” is “50”. The lower the value of the coordinate y, the higher the position of the GUI component, and the larger the value of the y coordinate, the lower the position of the GUI component. The value of the y coordinate of the GUI component “customer information registration screen” is the lowest among the y coordinate values of the partial images 51a of the GUI component possibilities. Therefore, the generation unit 132 arranges the GUI component “customer information registration screen” in the first row.

In the example in FIG. 4, for example, the y coordinates of the GUI component “case ID:” and the GUI component “111111” are “120”. The y coordinate values of the GUI component “case ID:” and the GUI component “111111” are the second largest among the partial images 51a of the GUI component possibilities. Therefore, the generation unit 132 arranges the GUI component “case ID:” and the GUI component “111111” in the second row. Since the GUI component “case ID:” and the GUI component “111111” are arranged in the same row, the generation unit 132 connects the GUI component “case ID:” and the GUI component “111111” by an edge.

### (Recognition Unit 133)

Returning to FIG. 1, similarly to the case of the generation unit 132, the recognition unit 133 generates various types of information used to execute processing for acquiring logs of software operation. For example, the recognition unit 133 generates sample arrangement data regarding arrangement of GUI components recognized as operable GUI components. The recognition unit 133 generates, as sample arrangement data, a sample graph structure in which GUI components are represented by nodes and an arrangement relationship between the GUI components is represented by an edge. For example, the recognition unit 133 generates a sample GUI component graph structure to be described later as the sample graph structure. The recognition unit 133 stores the generated sample arrangement data in the sample arrangement data storage unit 123.

The recognition unit 133 acquires arrangement data generated by the generation unit 132. For example, the recognition unit 133 acquires, from the arrangement data storage unit 122, the arrangement data generated by the generation unit 132.

The recognition unit 133 acquires a GUI component graph structure as the arrangement data generated by the generation unit 132. More specifically, the recognition unit 133 acquires a plurality of GUI component graph structures generated from a plurality of captured images by the generation unit 132. Then, the recognition unit 133 compares the plurality of GUI component graph structures. On the basis of a result of the comparison, the recognition unit 133 assigns a unique ID to a node of a GUI component that is operated from the GUI component graph structures. Thus, the recognition unit 133 generates a sample GUI component graph structure. The sample GUI component graph structure is a graph structure that serves as a sample of portions where operable GUI components are arranged.

The recognition unit 133 compares the same operation screens (that is, windows) side-by-side to specify, as an operation portion, a portion where there is a change in the image portion (e.g., a rectangle). Then, the recognition unit 133 assigns a unique ID to the specified operation portion to generate a sample GUI component graph structure.

For example, the recognition unit 133 specifies, as a portion where an operable GUI component is arranged, a portion where there is a change in the image portion of the GUI component possibility. Then, the recognition unit 133 allocates a unique ID to the specified portion to generate a sample GUI component graph structure for each operation screen (that is, window).

The recognition unit 133 compares graph structures of the same operation screen (that is, the same window) side-by-side to specify, as a portion of an operable GUI component, a portion where there is a change in the image portion. For example, text label portions are portions where there is no change in the image portion. On the other hand, text box portions are portions where there is a change in the image portion. In this case, the recognition unit 133 allocates unique IDs to the text box portions. The recognition unit 133 generates a sample GUI component graph structure by allocating a unique ID to a portion where there is a change in the image portion, such as a text box, a radio button, or a button.

FIG. 5 is an explanatory diagram illustrating an example of assignment processing of assigning a unique ID to a node of a GUI component that is operated from a GUI component graph structure. In the example in FIG. 5, the recognition unit 133 identifies a GUI component on which an operation is performed by superimposing a plurality of GUI component graph structures of a plurality of operation screens corresponding to the same operation screen (that is, the same window). That is, the recognition unit 133 superimposes a plurality of GUI component graph structures and specifies an arrangement portion where the GUI component has changed.

In the example in FIG. 5, the GUI component graph structure 61a, a GUI component graph structure 62a, a GUI component graph structure 63a, and a GUI component graph structure 64a are generated by the generation unit 132 from the captured image 41a of the operation screen, a captured image 42a of the operation screen, a captured image 43a of the operation screen, and a captured image 44a of the operation screen, respectively. The recognition unit 133 compares the GUI component graph structure 61a, the GUI component graph structure 62a, the GUI component graph structure 63a, and the GUI component graph structure 64a side-by-side to recognize, as an operable GUI component, a GUI component that changes in color or input value.

For example, in the GUI component graph structure 61a, the GUI component graph structure 62a, the GUI component graph structure 63a, and the GUI component graph structure 64a, there is no change in the GUI component at the portion where the GUI component “customer information registration screen” is arranged. On the other hand, there is a change in the GUI component at the portion where the GUI component “DENDEN Hanako” or a GUI component “YAMADA Taro” is arranged. From such a change in the GUI component, the recognition unit 133 specifies a GUI component that is operated.

The recognition unit 133 assigns a unique ID to a portion where a GUI component recognized as an operable GUI component is arranged. In the example in FIG. 5, the recognition unit 133 assigns an ID “1”, an ID “2”, an ID “3”, an ID “4”, an ID “5”, an ID “6”, an ID “7”, and an ID “8” to the portion where a GUI component “635498” is arranged, the portion where the GUI component “YAMADA Taro” is arranged, the portion where a GUI component “Kanagawa” is arranged, the portion where a GUI component”..., Takigawa-town, Yokosuka city” is arranged, the portion where a GUI component “black circle” is arranged, the portion where the GUI component “white circle” is arranged, the portion where a GUI component “save” is arranged, and the portion where a GUI component “register” is arranged, respectively.

Regarding assignment of a unique ID, for example, the recognition unit 133 extracts a representative GUI component graph structure from a plurality of GUI component graph structures. The recognition unit 133 solves a matching problem between the representative GUI component graph structure and the remaining GUI component graph structures to find graph structures that have the most in common with each other. The recognition unit 133 can use various graph matching algorithms to find graph structures that have the most in common with each other.

In a case where the recognition unit 133 has found graph structures that have the most in common with each other, the recognition unit 133 checks whether the GUI components at the corresponding portions match. For example, the recognition unit 133 checks whether the images or character strings match. In a case where the GUI components at the corresponding portions do not match, the recognition unit 133 determines that the GUI components arranged at this portion are operable GUI components. Then, the recognition unit 133 assigns a unique ID to this portion.

The recognition unit 133 assigns a unique ID to the arrangement portion where the GUI component has changed to generate a sample GUI graph structure. The recognition unit 133 stores the generated sample GUI graph structure in the sample arrangement data storage unit 123. The recognition unit 133 also stores the unique ID assigned to the arrangement portion in the sample arrangement data storage unit 123. In addition, the recognition unit 133 may store the active window identification information in the sample arrangement data storage unit 123. As described above, the recognition unit 133 registers, as a sample GUI component graph structure, a graph structure in which a unique ID has been assigned to an arrangement portion in a database (e.g., the sample arrangement data storage unit 123).

### (Specification Unit 134)

Returning to FIG. 1, the specification unit 134 specifies various types of information regarding software operation. For example, the specification unit 134 specifies information regarding an operation on a GUI component arranged on an operation screen (that is, a window) of an application.

The specification unit 134 acquires user operation events. Then, for each of the acquired operation events, the specification unit 134 determines which of the GUI components arranged on the operation screen corresponds to the acquired operation event. The specification unit 134 acquires operation events from the terminal device 200. The specification unit 134 may acquire the operation events from the operation data storage unit 121.

As in the case of the acquisition unit 131, the specification unit 134 acquires information regarding various operation events. For example, the specification unit 134 acquires information such as the type of the event (click or key), the position of the operation event, active window identification information, and a captured image of the window as information regarding the operation event.

The specification unit 134 generates a GUI component graph structure from a captured image of the operation screen acquired at the time of the operation event. The specification unit 134 extracts, among sample GUI component graph structures stored in the sample arrangement data storage unit 123, a sample GUI component graph structure most similar to the generated GUI component graph structure. Then, the specification unit 134 specifies an operation portion (e.g., a rectangular portion) from the sample graph structure on the basis of the position of occurrence of the operation. The specification unit 134 acquires a unique ID corresponding to the operation portion from the sample GUI component graph structure. In this way, the specification unit 134 specifies a GUI component that is operated from the position of occurrence of the operation event.

For example, first, the specification unit 134 chronologically takes a look at operation events (e.g., operation events acquired by the acquisition unit 131) acquired by processing of acquiring operation events. The specification unit 134 specifies an operation portion where a GUI component has been operated from captured images of the operation screen in time series for each operation event. The specification unit 134 newly generates a GUI component graph structure from the captured images of the operation screen. Then, on the basis of the portion where the operation has been performed in each operation event, the specification unit 134 specifies the operation portion where the GUI component has been operated from the newly generated GUI component graph structure. That is, the specification unit 134 specifies which GUI component in the newly generated GUI component graph structure has been operated.

Next, the specification unit 134 compares the newly generated GUI component graph structure with the sample GUI component graph structure stored in the sample arrangement data storage unit 123 to specify the GUI component arranged at the operation portion. From unique IDs included in the sample GUI component graph structure, the specification unit 134 acquires a unique ID corresponding to the operation portion specified from the newly generated GUI component graph structure. Then, on the basis of the acquired unique ID, the specification unit 134 specifies what the GUI component arranged at the specified operation portion is. For example, in a case where an acquired unique ID “7” is allocated to a button, the specification unit 134 specifies that the operated GUI component is a button.

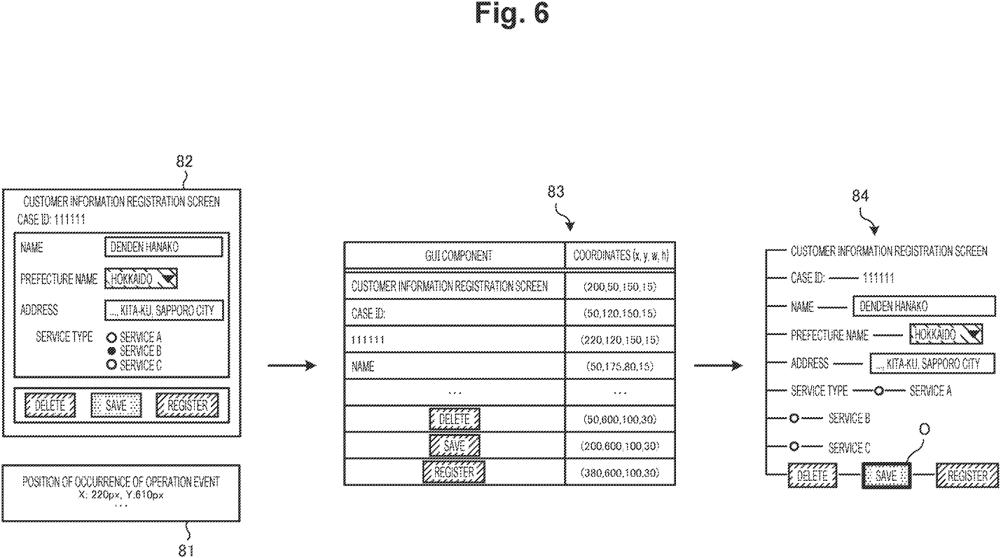

FIG. 6 is an explanatory diagram illustrating an example of GUI component specifying processing of specifying a GUI component at an operation portion from a captured image and an operation event. In the example in FIG. 6, first, the specification unit 134 acquires an operation event 81 and a captured image 82 of the operation screen. As illustrated in FIG. 6, the X coordinate of the position of occurrence of the operation event 81 is 220 px. The Y coordinate of the position of occurrence of the operation event 81 is 610 px. The captured image 82 is a captured image of the customer information registration screen.

Next, the specification unit 134 extracts frame (e.g., rectangular) portions and character string portions from the captured image 82 of the operation screen. As illustrated in FIG. 6, the specification unit 134 extracts partial images 83 of GUI component possibilities from the captured image 82 of the operation screen, as in the case of the generation unit 132. Then, the specification unit 134 generates a GUI component graph structure 84 from the partial images 83 of the GUI component possibilities to determine which of the partial images 83 of the GUI component possibilities corresponds to the GUI component of the operation event. The specification unit 134 determines which of the portions where the GUI component possibilities are arranged corresponds to the operation portion on the basis of the coordinates of the operation event.

In the example in FIG. 6, the specification unit 134 specifies that the portion where the GUI component “save” is arranged corresponds to an operation o. The portion where the GUI component “save” is arranged includes the position of occurrence of the operation event. The specification unit 134 specifies the portion of the GUI component in which the operation event has occurred from the position of occurrence of the operation event. In the example in FIG. 6, the coordinates “X: 220 px, Y: 610 px” of the position of occurrence of the operation event 81 are in the portion where the GUI component “save” is arranged. Thus, the specification unit 134 specifies the portion where the GUI component “save” is arranged as the portion of the GUI component in which the operation event has occurred.

Returning to FIG. 1, the specification unit 134 specifies a sample GUI component graph structure corresponding to a generated GUI component graph structure from among sample GUI component graph structures registered in a database (e.g., the sample arrangement data storage unit 123). Then, the specification unit 134 specifies an arrangement portion corresponding to a GUI component in which an operation event has occurred from the specified sample GUI component graph structure, and specifies a unique ID assigned to the specified arrangement portion.

Regarding specification of the sample GUI component graph structure, as an example, the specification unit 134 specifies a sample GUI component graph structure that matches the active window identification information of the operation event to be identified by (that is, the target operation event of) the identification information. As another example, the specification unit 134 extracts a maximum common subgraph by solving a graph matching problem between a GUI component graph structure generated from a target operation event and a sample GUI component graph structure in a database (e.g., the sample arrangement data storage unit 123). For example, the specification unit 134 specifies a sample GUI component graph structure in which the edit distance is the smallest according to an algorithm using the edit distance. Alternatively, the specification unit 134 specifies a sample GUI component graph structure in which the edit distance is equal to or less than a set threshold.

Regarding identification of a unique ID, as an example, the specification unit 134 extracts a maximum common subgraph by solving a graph matching problem between a GUI component graph structure generated from a captured image of a target operation event and the identified sample GUI component graph structure described above. In this case, it is desirable to acquire, as a processing result, a correspondence relationship between GUI components at portions common in the GUI component graph structure of the target operation event and the sample GUI component graph structure. Then, the specification unit 134 acquires a unique ID assigned to the sample GUI component graph structure corresponding to the GUI component at an operation portion specified in advance, as a unique ID of the operation portion. In a case where a unique ID has not been assigned to the corresponding sample GUI component graph structure, the arrangement portion in the sample GUI component graph structure is not the operation portion. In this case, the specification unit 134 does not generate an operation log.

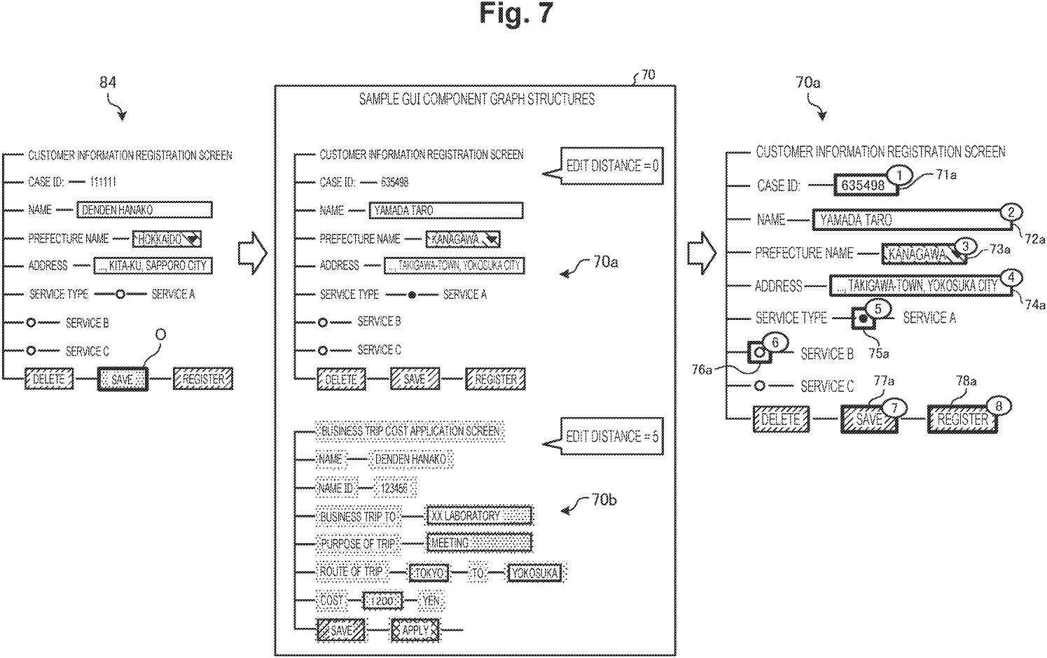

FIG. 7 is an explanatory diagram illustrating an example of unique ID specifying processing of specifying a unique ID of an operation portion. In the example in FIG. 7, on the basis of the degree of matching between the GUI component graph structure 84 described above with reference to FIG. 6 and a sample GUI component graph structure stored in the sample arrangement data storage unit 123, the specification unit 134 specifies a sample GUI component graph structure having high commonality with the GUI component graph structure 84.

For example, the specification unit 134 uses a graph matching problem technique to specify a sample GUI component graph structure having high commonality with the GUI component graph structure 84. For example, the specification unit 134 uses an algorithm using the edit distance to calculate the edit distances of a sample GUI component graph structure 70a and a sample GUI component graph structure 70b included in a plurality of sample GUI component graph structures 70. Then, the specification unit 134 specifies a sample GUI component graph structure in which the edit distance is the smallest. Alternatively, the specification unit 134 specifies a sample GUI component graph structure in which the edit distance is equal to or less than a set threshold.

In the example in FIG. 7, for example, the specification unit 134 calculates the edit distance on the basis of the graph structure without considering the description of each node. For example, node structures of the GUI component graph structure 84 and the sample GUI component graph structure 70a are compared in order from the top. The node structure in the first to ninth rows of the GUI component graph structure 84 matches the node structure in the first to ninth rows of the sample GUI component graph structure 70a. Therefore, the edit distance of the sample GUI component graph structure 70a is “0”.

On the other hand, the node structure in the first to fifth rows of the GUI component graph structure 84 matches the node structure in the first to fifth rows of the sample GUI component graph structure 70b. However, the number of nodes is “3” in the sixth row of the GUI component graph structure 84, and the number of nodes is “4” in the sixth row of the sample GUI component graph structure 70b. Therefore, the edit distance in the sixth row is “1”. The number of nodes is “2” in the seventh row of the GUI component graph structure 84, and the number of nodes is “3” in the seventh row of the sample GUI component graph structure 70b. Therefore, the edit distance in the seventh row is “1”. The number of nodes is “2” in the eighth row of the GUI component graph structure 84, and the number of nodes is “2” in the eighth row of the sample GUI component graph structure 70b. Therefore, the edit distance in the eighth row is “0”. The number of nodes is “3” in the ninth row of the GUI component graph structure 84, but there are no nodes in the ninth row of the sample GUI component graph structure 70b. Therefore, the edit distance in the ninth row is “3”. The specification unit 134 calculates the sum of these edit distances, and obtains “5” as the edit distance of the sample GUI component graph structure 70b.

Note that the specification unit 134 may calculate the edit distance in consideration of the description of each node. The specification unit 134 may calculate the edit distance of the sample GUI component graph structure on the basis of the node structure and the descriptions of the nodes. For example, the specification unit 134 may use OCR to acquire the description of each node as text. Then, the specification unit 134 may compare the acquired character strings. In a case where the character strings are different from each other, the specification unit 134 may increment the edit distance. In the case of comparison by text, for example, the specification unit 134 may calculate the edit distance of the character string.

In addition, the specification unit 134 may compare the image portions of the nodes. In a case where these image portions are different from each other, the specification unit 134 may increment the edit distance. For example, the specification unit 134 represents the image portions by vectors. Then, the specification unit 134 calculates a similarity between the vectors. In a case where the calculated similarity is equal to or greater than a threshold, the specification unit 134 determines that the image portions are the same. In a case where the calculated similarity is less than the threshold, it is determined that the image portions are different from each other.

In the example in FIG. 7, the specification unit 134 specifies the sample GUI component graph structure 70a as a sample GUI component graph structure having high commonality with the GUI component graph structure 84. The specification unit 134 solves a graph matching problem to specify, from the sample GUI component graph structure 70a, an arrangement portion corresponding to the arrangement portion of each GUI component in the GUI component graph structure 84. In the example in FIG. 7, from among the ID “1”, the ID “2”, the ID “3”, the ID “4”, the ID “5”, the ID “6”, the ID “7”, and the ID “8”, the ID “7” is specified as the unique ID of the arrangement portion corresponding to the operation O. As described above with reference to FIG. 5, the ID “7” has been assigned to the portion where the GUI component “save” is arranged. In other words, the acquired unique ID “7” is allocated to a “save” button. Thus, the specification unit 134 can specify that the operation O is an operation for the GUI component “save”. In addition, the specification unit 134 can specify that the operated GUI component is the “save” button.

### (Determination Unit 135)

Returning to FIG. 1, the determination unit 135 determines whether to record various types of information regarding software operation. The determination unit 135 determines whether there is a change in the operation event. The determination unit 135 takes a look at operation events one-by-one in chronological order, and determines whether a different GUI component has been operated in the previous operation event. For example, the determination unit 135 processes operation events acquired by the specification unit 134 in order of time of occurrence of the event. Then, the determination unit 135 determines whether the operation portion of the target operation event is different from the operation portion of the previous operation event.

For example, the determination unit 135 compares an operation event with the previous operation event that occurred immediately before that operation event, and determines whether the GUI components at the operation portions are different from each other on the basis of the comparison result. More specifically, the determination unit 135 determines whether the unique ID of the arrangement portion corresponding to the operation matches the unique ID of the arrangement portion corresponding to the previous operation. Thus, the determination unit 135 determines whether there is a change in the operation event.

### (Recording Unit 136)

The recording unit 136 records various types of information regarding software operation. In a case where the determination unit 135 determines that various types of information regarding software operation are to be recorded, the recording unit 136 records the various types of information. For example, the recording unit 136 stores log data regarding logs of software operation in the log data storage unit 124.

In a case where the determination unit 135 determines that the operation portion of the target operation event is different from the operation portion of the previous operation event, the recording unit 136 records the target operation event in an operation log (e.g., the log data storage unit 124). For example, in a case where the GUI components at the operation portions are different from each other, the recording unit 136 records the operation event as an operation log. More specifically, in a case where the unique ID of the arrangement portion corresponding to the operation does not match the unique ID of the arrangement portion corresponding to the previous operation, the operation event is recorded as an operation log. As described above, in a case where there is a change in the operation event, the recording unit 136 records the operation event in the operation log.

### 3. Flow of Operation Log Acquisition Processing

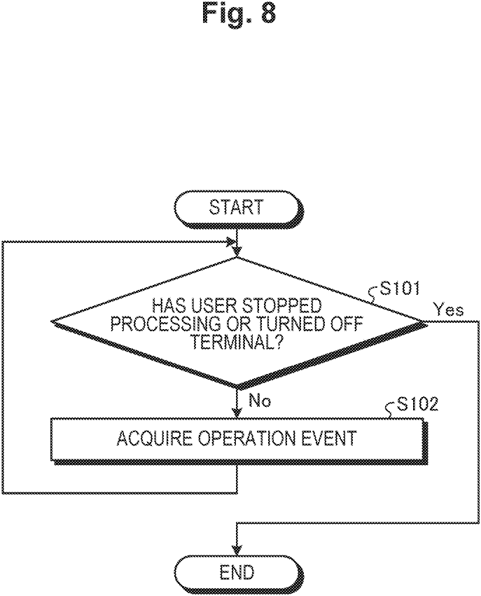

Next, a procedure of operation log acquisition processing by the data processing device 100 according to the embodiment will be described with reference to FIGS. 8, 9, and 10.

FIG. 8 is a flowchart illustrating an example of processing for acquiring an operation event, executed by the data processing device 100 according to the embodiment.

As illustrated in FIG. 8, first, the acquisition unit 131 of the data processing device 100 determines whether a user has stopped processing or turned off the terminal device 200 (step S101).

In a case where it is determined that the user has not stopped the processing and has not turned off the terminal device 200 (step S101: No), the acquisition unit 131 acquires an operation event (step S102). For example, the acquisition unit 131 acquires, as the operation event, the time of occurrence of the operation, the event type, the portion where the operation has been performed, and a captured image of the window. Then, the acquisition unit 131 executes step S101 again.

In a case where it is determined that the user has stopped the processing or turned off the terminal device 200 (step S101: Yes), the processing for acquiring an operation event ends.

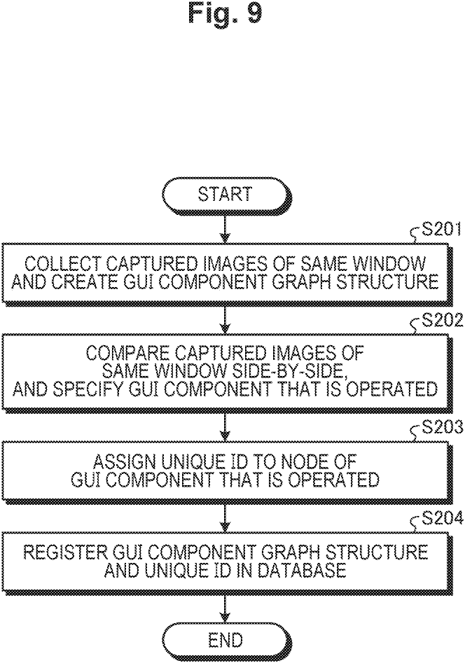

FIG. 9 is a flowchart illustrating an example of processing for generating a sample GUI graph structure, executed by the data processing device 100 according to the embodiment.

As illustrated in FIG. 9, first, the generation unit 132 of the data processing device 100 collects captured images of the same window acquired by the acquisition unit 131, and creates a GUI component graph structure (step S201). For example, the generation unit 132 generates a GUI component graph structure on the basis of the positions of image portions of GUI component possibilities.

Next, the recognition unit 133 of the data processing device 100 compares the captured images of the same window side-by-side, and specifies a GUI component that is operated from the GUI component graph structure generated by the generation unit 132 (step S202). For example, the recognition unit 133 specifies, from the graph structure, the arrangement portion of the GUI component that is operated.

Next, the recognition unit 133 assigns a unique ID to the GUI that is operated (step S203). For example, the recognition unit 133 assigns a unique ID to the arrangement portion of the GUI component that is operated. As an example, the recognition unit 133 generates the above-described sample GUI component graph structure as a sample of portions where operable GUI components are arranged by comparing graph structures of the same window.

Next, the recognition unit 133 registers the GUI component graph structure and the unique ID in the database (step S204). For example, the recognition unit 133 stores, in the sample arrangement data storage unit 123, a plurality of GUI component graph structures and a sample GUI component graph structure generated from the plurality of GUI component graph structures.

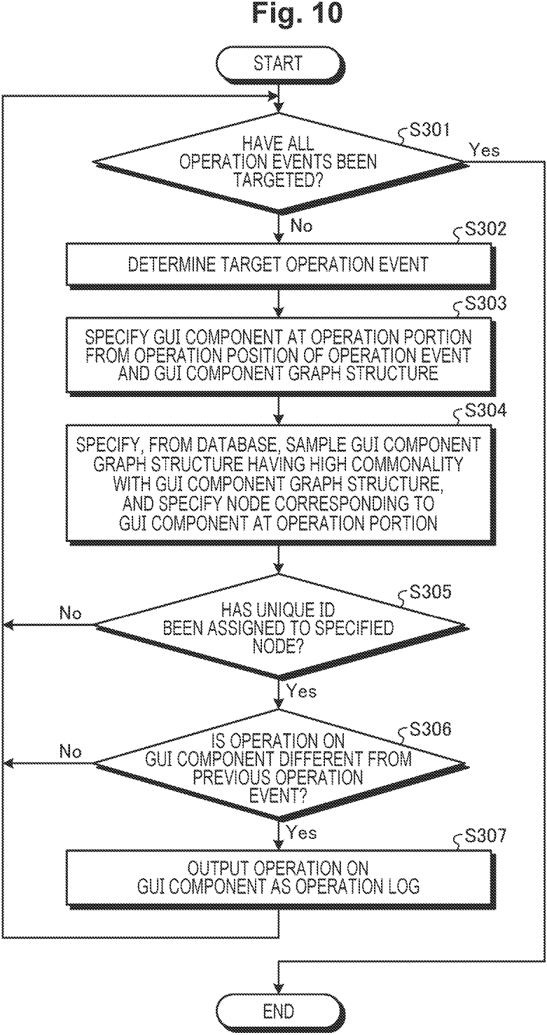

FIG. 10 is a flowchart illustrating an example of processing for generating an operation log, executed by the data processing device 100 according to the embodiment.

As illustrated in FIG. 10, first, the specification unit 134 of the data processing device 100 determines whether all operation events have been targeted (step S301).

In a case where it is determined that all the operation events have been targeted (step S301: Yes), the processing for generating an operation log ends.

In a case where it is determined that not all the operation events have been targeted (step S301: No), the specification unit 134 determines a target operation event (step S302).

Next, from an operation position of the operation event and a GUI component graph structure extracted from the operation screen, the specification unit 134 specifies a GUI component at the operation portion (step S303).

Next, the specification unit 134 specifies, from a database, a sample GUI component graph structure having high commonality with the GUI component graph structure, and specifies a node corresponding to the GUI component at the operation portion (step S304).

For example, the specification unit 134 specifies, from the sample arrangement data storage unit 123, a sample GUI component graph structure having the highest commonality with the GUI component graph structure. Alternatively, the specification unit 134 specifies, from the sample arrangement data storage unit 123, a sample GUI component graph structure in which the degree of commonality of the graph structure satisfies a threshold. As an example, the specification unit 134 specifies, from the sample arrangement data storage unit 123, a sample GUI component graph structure in which the edit distance is equal to or less than a threshold.

Next, the specification unit 134 determines whether a unique ID has been assigned to the specified node (step S305).

In a case where it is determined that a unique ID has not been assigned to the specified node (step S305: No), the specification unit 134 executes step S301 again.

In a case where it is determined that a unique ID has been assigned to the specified node (step S305: Yes), the determination unit 135 of the data processing device 100 determines whether the operation on the GUI component is different from the previous operation event (step S306).

In a case where it is determined that the operation on the GUI component is the same as the previous operation event (step S306: No), the specification unit 134 executes step S301 again.

In a case where it is determined that the operation on the GUI component is different from the previous operation event (step S306: Yes), the recording unit 136 of the data processing device 100 outputs the operation on the GUI component as an operation log (step S307). Then, the specification unit 134 executes step S301 again.

Note that the “processing for generating a sample GUI graph structure” described above with reference to FIG. 9 may be executed in the same process as the “processing for generating an operation log” described above with reference to FIG. 10. In this case, step S202, step 203, and step S204 are executed before step S301.

### 4. Others

Among the pieces of processing described in the above embodiment, a part of the processing described as being automatically performed can also be manually performed. Alternatively, all or part of the processing described as being performed manually can be automatically performed by a known method. In addition, the above-described processing procedures, specific names, and information including various types of data and parameters described in the document and illustrated in the drawings can be freely changed unless otherwise specified. For example, the various types of information illustrated in the drawings are not limited to the illustrated information.

In addition, each component of each device that has been illustrated is functionally conceptual, and is not necessarily physically configured as illustrated. That is, a specific form of distribution and integration of individual devices is not limited to the illustrated form, and all or a part of the configuration can be functionally or physically distributed and integrated in any unit according to various loads, usage conditions, and the like. Furthermore, all or any part of each processing function performed in each device can be implemented by a CPU and a program analyzed and executed by the CPU, or can be implemented as hardware by wired logic.

For example, a part of or the entire storage unit 120 illustrated in FIG. 1 may be held in a storage server or the like instead of being held by the data processing device 100. In this case, the data processing device 100 accesses the storage server to acquires various types of information such as operation data.

### 5. Hardware Configuration

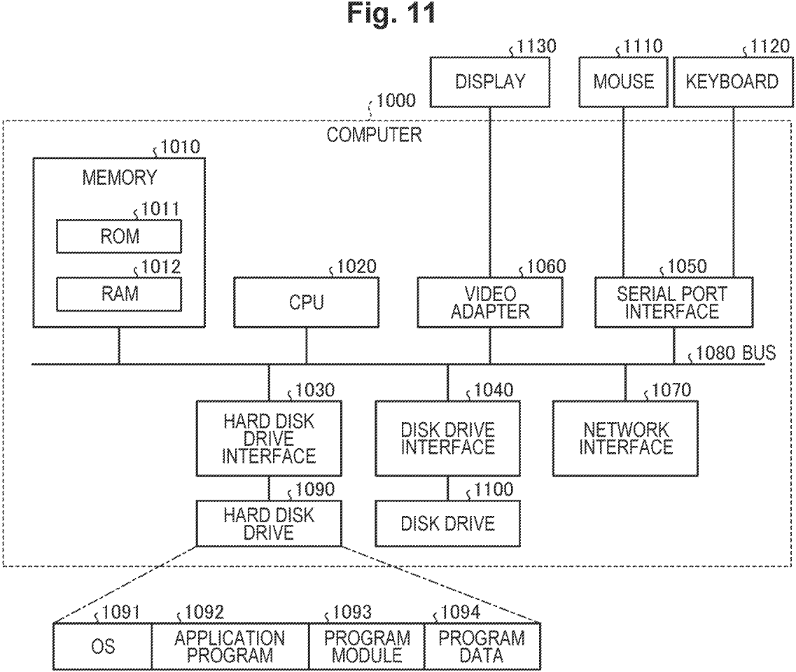

FIG. 11 is a diagram illustrating an example of a hardware configuration. The data processing device 100 according to the above-described embodiment is achieved by, for example, a computer 1000 having a configuration as illustrated in FIG. 11.

FIG. 11 illustrates an example of a computer that executes a program to achieve the data processing device 100. The computer 1000 includes, for example, a memory 1010 and a CPU 1020. Further, the computer 1000 also includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an operating system (OS) 1091, an application program 1092, a program module 1093, and program data 1094. That is, the program that defines each piece of processing of the data processing device 100 is implemented as the program module 1093 in which a code executable by the computer 1000 is described. The program module 1093 is stored in, for example, the hard disk drive 1090. For example, the program module 1093 for executing processing similar to the functional configurations in the data processing device 100 is stored in the hard disk drive 1090. Note that the hard disk drive 1090 may be replaced with a solid state drive (SSD) .

Furthermore, setting data used in the processing of the above-described embodiment is stored, for example, in the memory 1010 or the hard disk drive 1090 as the program data 1094. Then, the CPU 1020 reads the program module 1093 and the program data 1094 stored in the memory 1010 or the hard disk drive 1090 to the RAM 1012, and executes the program module 1093 and the program data 1094 as necessary.

Note that the program module 1093 and the program data 1094 are not limited to being stored in the hard disk drive 1090, and may be stored in, for example, a detachable storage medium and read by the CPU 1020 via the disk drive 1100 or the like. Alternatively, the program module 1093 and the program data 1094 may be stored in another computer connected via a network (e.g., LAN or WAN). Then, the program module 1093 and the program data 1094 may be read by the CPU 1020 from the other computer via the network interface 1070.

### 6. Effects

As described above, the data processing device 100 according to the embodiment includes the acquisition unit 131, the generation unit 132, and the recognition unit 133.

In the data processing device 100 according to the embodiment, the acquisition unit 131 acquires a plurality of images of a window. Furthermore, in the data processing device 100 according to the embodiment, the generation unit 132 extracts image portions of GUI component possibilities from each one of the plurality of images acquired by the acquisition unit 131, and generates, for each acquired image, arrangement data regarding arrangement places where the extracted image portions are arranged. Furthermore, in the data processing device 100 according to the embodiment, the recognition unit 133 compares image portions of predetermined GUI component possibilities in which arrangement places correspond to each other between a plurality of pieces of arrangement data generated by the generation unit 132, and recognizes the predetermined GUI component possibilities as operable GUI components in a case where the image portions of the predetermined GUI component possibilities are different from each other.

This allows the data processing device 100 according to the embodiment to easily collect operation logs.

Furthermore, in the data processing device 100 according to the embodiment, the generation unit 132 collects a plurality of images of the same window from a plurality of images acquired by the acquisition unit 131, extracts image portions of GUI component possibilities from each of the collected images, and generates arrangement data for each of the collected images.

This allows the data processing device 100 according to the embodiment to specify an operable GUI component in the window from the images of the window, and operation logs can be easily collected regardless of the application.

Furthermore, in the data processing device 100 according to the embodiment, the recognition unit 133 generates, on the basis of a plurality of pieces of arrangement data, sample arrangement data regarding arrangement places where the predetermined GUI component possibilities recognized as operable GUI components are arranged.

This allows the data processing device 100 according to the embodiment to perform robust operation recognition against expansion and reduction of an image portion of a GUI component.

In addition, the data processing device 100 according to the embodiment includes the specification unit 134 that compares arrangement data generated from an image of a predetermined window in which an operation event has occurred with sample arrangement data generated by the generation unit 132, specifies an arrangement place corresponding to the position in which the operation event has occurred from the sample arrangement data, and specifies that the GUI component arranged at the specified arrangement place has been operated.

This allows the data processing device 100 according to the embodiment to automatically collect an operation log from the window.

Furthermore, in the data processing device 100 according to the embodiment, the generation unit 132 generates, as arrangement data, a graph structure in which image portions of GUI component possibilities are represented by nodes and an arrangement relationship between the image portions of the GUI component possibilities is represented by an edge. Furthermore, in the data processing device 100 according to the embodiment, the recognition unit 133 compares a plurality of graph structures generated by the generation unit 132, and generates, as the sample arrangement data on the basis of a result of the comparison, a sample graph structure in which GUI components are represented by nodes and an arrangement relationship between the GUI components is represented by an edge. Furthermore, in the data processing device 100 according to the embodiment, the specification unit 134 calculates a similarity between a graph structure generated from an image of a predetermined window in which an operation event has occurred and a sample graph structure, and specifies an arrangement place corresponding to the position in which the operation event has occurred from the sample graph structure in a case where the calculated similarity satisfies a threshold.

This allows the data processing device 100 according to the embodiment to collect operation logs in common without an operation log collection mechanism being developed for each application.

Although some embodiments of the present application have been described above in detail with reference to the drawings, these are merely examples, and the present invention is not limited to specific examples. The features described in the present specification can be implemented in other forms with various modifications and improvements on the basis of knowledge of those skilled in the art, including the aspects described in the section “Description of Embodiments”.

Furthermore, the above-described data processing device 100 may be achieved by a plurality of server computers, and depending on functions, the configuration can be flexibly changed, for example, by calling an external platform or the like with an application programming interface (API), network computing, or the like.

In addition, the “sections”, “modules”, and “units” described above can be read as “means”, “circuits”, or the like. For example, the recognition unit can be read as recognition means or a recognition circuit.

Reference Signs List

| | |
|---|---|
| 1 | Operation log acquisition system |
| 100 | Data processing device |
| 110 | Communication unit |
| 120 | Storage unit |
| 121 | Operation data storage unit |
| 122 | Arrangement data storage unit |
| 123 | Sample arrangement data storage unit |
| 124 | Log data storage unit |
| 130 | Control unit |
| 131 | Acquisition unit |
| 132 | Generation unit |
| 133 | Recognition unit |
| 134 | Specification unit |
| 135 | Determination unit |
| 136 | Recording unit |
| 200 | Terminal device |

1. A data processing device comprising:
an acquisition unit, implemented using one or more computing devices, configured to acquire a plurality of images of a window;
a generation unit, implemented using one or more computing devices, configured to generate, after extracting a plurality of image portions of graphic user interface (GUI) component possibilities from eachof the acquired plurality of images, arrangement data regarding a plurality of arrangement places where the extracted plurality of image portions are arranged; and
a recognition unit, implemented using one or more computing devices, configured to determine, after comparing a plurality of image portions of predetermined GUI component possibilities in which arrangement places correspond to each other between a plurality of pieces of the generated arrangement data, the predetermined GUI component possibilities as operable GUI components based on the plurality of image portions of the predetermined GUI component possibilities being different from each other.

2. The data processing device according to claim 1, wherein the generation unit is configured to:
collect a plurality of images of the window from the plurality of images acquired by the acquisition unit,
extract the image portions of the GUI component possibilities from each of the collected plurality of images, and
generate the arrangement data for each of the collected plurality of images.

3. The data processing device according to claim 1, wherein the recognition unit is configured to, based on the plurality of pieces of the generated arrangement data, generate sample arrangement data regarding arrangement places where the predetermined GUI component possibilities determined as the operable GUI components are arranged.

4. The data processing device according to claim 3, further comprising:
a specification unit, implemented using one or more computing devices, configured to:
compare the arrangement data generated from an image of a predetermined window in which an operation event has occurred with the generated sample arrangement data,
specify an arrangement place corresponding to a position in which the operation event has occurred from the sample arrangement data, and
specify that a GUI component arranged at the specified arrangement place has been operated.

5. The data processing device according to claim 4, wherein:
the generation unit is configured to generate, as the arrangement data, a graph structure in which (i) image portions of GUI component possibilities are represented by nodes and (ii) an arrangement relationship between the image portions of the GUI component possibilities is represented by an edge,
the recognition unit is configured to:
compare a plurality of graph structures generated by the generation unit, and
generate, as the sample arrangement data based ona result of the comparison, a sample graph structure in which (i) GUI components are represented by nodes and (ii) an arrangement relationship between the GUI components is represented by an edge, and the specification unit is configured to:
calculatea similarity between the graph structure generated from the image of the predetermined window in which the operation event has occurred and the sample graph structure, and
based on the calculated similarity being satisfied a threshold, specify an arrangement place corresponding to the position in which the operation event has occurred from the sample graph structure .

6. A data processing method executed by a computer, the method comprising:
acquiring a plurality of images of a window;
generating, after extracting a plurality of image portions of graphic user interface (GUI) component possibilities from each of the acquired plurality of images, arrangement data regarding a plurality of arrangement places where the extracted plurality of image portions are arranged; and
determining,, after comparing a plurality of image portions of predetermined GUI component possibilities in which arrangement places correspond to each other between a plurality of pieces of the generated arrangement data, the predetermined GUI component possibilities as operable GUI components based on the image portions of the predetermined GUI component possibilities being different from each other.

7. A non-transitory computer recording storing a data processing program, wherein execution of the data processing program causes one or more computers to perform operations comprising:
acquiring a plurality of images of a window;
generating, after extracting a plurality of image portions of graphic user interface (GUI) component possibilities from each of the acquired plurality of images, arrangement data regarding a plurality of arrangement places where the extracted plurality of image portions are arranged ; and
determining, after comparing a plurality of image portions of predetermined GUI component possibilities in which arrangement places correspond to each other between a plurality of pieces of the generated arrangement data, the predetermined GUI component possibilities as operable GUI components based on the plurality of image portions of the predetermined GUI component possibilities being different from each other.
